(19) United States
(12) Patent Application Publication
(10) Pub. No.: US 2025/0348835 A1
(43) Pub. Date: Nov. 13, 2025

(54) LAST MILE DELIVERY BUSINESS MODEL

(71) Applicant: Earl J Braxton, Utica, MI (US)

(72) Inventor: Earl J Braxton, Utica, MI (US)

(21) Appl. No.: 18/887,895

(22) Filed: Sep. 17, 2024

Related U.S. Application Data
(60) Provisional application No. 63/646,054, filed on May 13, 2024.

(51) Int. Cl. G06Q 10/0834; G06Q 10/0836

(52) U.S. Cl. CPC G06Q 10/0834; G06Q 10/0836

(57) ABSTRACT

Disclosed is a franchise business model for last mile package delivery systems including the steps of first establishing a franchise corporation with a centralized computer system and selling franchises to a purchaser franchisee that is either a driver himself or he employs driver contractors within his designated territories and locations purchased by the franchisee. When purchasing a franchise, the franchisee becomes interconnected within at least one logistic server computer within the centralized computer system for receiving information about package orders from a seller that has entered into a business relationship with the franchisee by establishing a business relationship with a number of sellers that will transmit order information to the seller. A last mile driver delivers packages within his designated territory owned by the franchisee. A designated seller will drop off those packages at a central location for the last mile driver to be picked up for localized delivery.

### CROSS-REFERENCE TO RELATED APPLICATIONS

This application claims the benefit under 35 U.S.C. 119 (e) of U.S. Provisional Patent Application No. 63/646,054, filed on May 13, 2024.

### BACKGROUND OF THE INVENTION

### 1. Field of the Invention

The present invention relates to a franchise product delivery system and more particularly, the invention relates and focuses on a separate delivery system franchise or distributorship scheme for the last mile of the package or food delivery for the entity that received an order from a buyer. Below, we reference this seller as a tier one customer such as a big box store from our parent franchise corporation. The last mile is defined as the final destination for a product package referred to as the ultimate customer referred to here as tier two customer destination.

### 2. Description of the Prior Art

Conventional package delivery is direct from the seller, all the way to the individual whether at home or business for delivery. This conventional delivery system not only delivers from the seller, but also includes a package delivery system including the last mile. The established freight companies are having some labor problems as are all employers in a tight and unmotivated labor market.

Currently many of the food and package delivery industries such as Door Dash®, may be using delivery personnel which could be a major safety problem. Today, Amazon® employs more than 275,000 drivers, who safely deliver more than 10 million customer packages every day. Amazon has generated more than $26 billion in revenue for the small businesses they sell for and have positively impacted many communities across the globe. However, as an example, Door Dash® and the others may have long term problems with an employee/contractor debate. It may be noted that Door Dash® has yet to turn a consistent profit.

In general, delivery companies are short of help and the currently popular “free shipping” or free freight psychology may soon hit a brick wall. In many cases companies are having unrealistic package delivery quotas for their delivery drivers creating driver anxiety.

Consequently, sellers are in danger of exercising excess control on the work that their driver subcontractors do in order to achieve those quotas and may be in danger of their delivery subcontractors being classified as employees, creating more problems.

In high volume locales, the driver subcontractors that Amazon and the other sellers are using may not be viable long term. Some of the reasons for worker fatigue are lack of desire, lack of business history, work ethic, and possible challenges to the delivery driver contractor standing to name a few. It would be desirable to bring a higher caliber of drivers to the delivery system. It should be noted that Amazon driver attrition rates were 123 percent in 2019 before jumping to 159 percent in 2020, according to internal data in the Bureau of Statistics report dated Jun. 17, 2022.

In contrast, turnover rates across the conventional US transportation and warehouse sectors were much lower, i.e. 46% and 59% respectively in 2019 and 2020, according to the report. The managerial cost of supervising unmotivated contractor employees is also very high. In 2021, 18.3 percent of Amazon®'s driver subcontractors had employee injuries reported to workers compensation and disability claims.

Therefore, the delivery industry needs better, more reliable and safe methods for last mile deliveries.

### SUMMARY OF THE INVENTION

In accordance with the above-noted advantages and desires of the industry, the present invention provides a cost efficient, reliable, and interactive customer-oriented franchise based relationship. Designated as a last mile delivery contractor or franchise business model wherein an individual engages in our franchise to receive a substantial volume of packages from one or more tier one customer sellers to the franchisee's or distributor designated area within the franchisee's designated neighborhood or geographic territory relying on the last mile contractor to deliver all packages to the ultimate destination tier two customers located within their territory. This will alleviate many of the aforementioned problems with the prior art because the last mile delivery contractor will be a recognized independent contractor who will finance their own equipment and will have a home or office in or near the territory. This concept can advantageously be a highly desirable work from home occupation that can sustain through time.

This last mile delivery concept is inspired by the relationships established by WWII British air raid wardens and their wards. The warden was someone everyone got to know and that made for an effective relationship that achieved the objective. The familiarity with both the tier one sellers and their tier two customers afforded by the last mile delivery contractor system will contribute to more efficient interaction between all parties with the ability to reduce redundancy and control the cost. The advantages of the last mile delivery system are economic, with greater customer safety, a reduction in porch banditry and an improvement in all around customer satisfaction. The present last mile delivery contractor concept will bring relief from the current labor shortage and dramatically lower the turnover rate while increasing the volume of products shipped. Reduced costs to tier one customer sellers include the cost of labor that is currently lost to workers compensation and disability claims, as well as the high cost of managing their current delivery drivers.

When addressing food and/or package deliveries for the last mile, restaurants and delivery services in general can give discounts for multiple deliveries within a territory. The last mile contractor or franchisee will also earn revenue in the form of tips for food delivery.

As such, our last mile concept will reduce costs by minimizing delivery redundancies by having separate multiple drivers in the same area. Most of the last mile franchisee sub-contractors will use family and friends for their drivers. The last mile franchise will be similar to the family restaurant that has existed in America.

In essence, a selling store corporation, i.e. a tier one customer, can load up a truck with a plethora of packages to be delivered to an independent last mile franchisee or contractor for a specific area or zip code. Once the last mile driver has his load of packages, he will then deliver those packages to the last mile customer i.e. the tier two customers, in their territory.

One specific preferred aspect has certain features including a distinct cost advantage that occurs by the establishment of multiple package deliveries to the same territory. This is accomplished by eliminating multiple trips to the same area thus reducing the tier one customer's delivery cost. This can be further optimized through the expansion of the central corporation's last mile franchise's national data base and contact point for all products. This will grow as the number of last mile franchisees and distributors increases in the last mile franchise owned by the individuals.

In the event of out of stock and package returns the franchise will have its procedures.

Since many orders have multiple products on the same order, some of the products may be out of stock. Again, the last mile franchisee or distributor can be both a method of cost saving by preventing redundant delivery costs and facilitating more efficient service. The cost of processing product returns will provide a major cost savings with the last mile concept. For example, Walmart® has 30% returns and Amazon® has between 5% and 15% depending on the product. The cost savings of having one delivery and pickup address for multiple delivery functions i.e. original order, back orders, and returns, etc. will lower costs, improve efficiency, enhance service quality, lower managerial requirements, and facilitate a more efficient return policy.

Although the invention will be described by way of examples hereinbelow for specific aspects having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different aspects and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF DRAWINGS

For a further understanding of the nature and advantages of the expected scope and various aspects of the present invention, reference shall be made to the following detailed description, and when taken in conjunction with the accompanying drawings, in which like parts are given the same reference numerals, and wherein:

FIG. 1 is a flowchart of the steps of a franchise business model methodology made in accordance with the present invention.

### DETAILED DESCRIPTION OF THE INVENTION

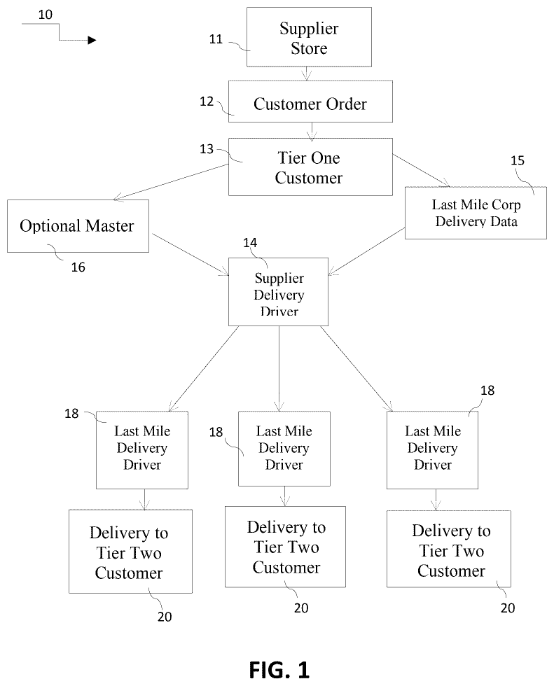

In accordance with the present invention, we refer now to the drawing in detail. FIG. 1 is a view of a flowchart of the steps of the business model for the instant franchise. These franchise steps are generally indicated by the numeral 10, which also includes a first step of an order 12 from an ultimate buyer. Alternatively, a tier two customer may need to order a product from a manufacturer or supplier store 11 in order to fulfill the original order. The manufacturer or supplier store 11 then sends the order back to the tier one customer 13 to fulfill the order. Then, the supplier store 11 contacts the last mile franchise corporation database through their in-house dispatcher. The product packages are delivered to the last mile corporation franchisee or distributor by the tier one customer's dispatcher 14. In some cases, with a consistently large package volume, the last mile franchisee or distributor may elect for an additional charge to be negotiated and paid to the last mile contractor to pick up packages at a local site designated by the tier one customer seller 18 or alternatively to one of the last mile corporation's master franchisees 16. This then triggers a drop off to a last mile contractor driver 18. A last mile contractor driver 18 then picks up the package to be delivered within his or her designated territory for them to make the last mile delivery.

Payment arrangements are made by the last mile corporation including a negotiated fee schedule with the tier one customer seller that will be paid to the last mile franchise corporation and the last mile corporation will pay the last mile corporation franchisee or distributor and the master franchisee, if in place. The last mile corporation will consult with the last mile franchise corporation franchisee and the last mile corporation master franchisee to determine charges for all different types of package deliveries.

Once the delivery has been made, it is then verified by both a picture at the delivery site and a notice of delivery and the picture is E-mailed to the tier one customer seller. The last mile contractor driver 18 will enter this activity daily in his computer which is then sent back to the supplier store and payment is made to the last mile corporation within 15 to 30 days. The last mile corporation then pays the last mile corporation franchise within 15 to 30 days of receiving its payment. If a master franchise is in place in the territory, they would also receive payment from the last mile corporation.

This last mile contractor franchise concept will put an end to the anonymous deliveryman and add a name and face that will encourage familiarity and that will be a major improvement on the current anonymous deliveryman system. This last mile concept is to install a mature, personable person as a franchisee or contractor, acting essentially as a last mile Ambassador who will be somebody that everybody will get to know and trust. This familiarity initiated by the last mile contractor concept will contribute to positive interactions and less redundancy initiating goodwill and at the same time lowering tier one customer's overall costs.

It is anticipated that there will be a large number of franchise applicants due to the natural desire for people to work for themselves and participate in the American Dream, by setting their own hours, working from home, and the positive financial standing of many of the applicants. The initial source for some of the anticipated franchisee applicants could, in fact, be existing conventional tier one customer's middle management and drivers. Several of the retail tier one customers allow their drivers to deliver for other tier one customers to avoid their driver contractors from being adjudicated as employees.

Point calculations for franchisee selection could be based on some of the following criteria, i.e. education, work history, net worth, home ownership in the territory, business building, rental or ownership in the territory, qualifying as a Veteran, driving record, arrest record, computer skill set, quality of the franchisee drop-off site, and/or the delivery experience of existing drivers, among any of other factors that would pertain.

In one important aspect of the present invention, a big box store shipper at a tier one customer seller would be responsible for supplying orders to the last mile shipping company. In this aspect, the tier two customer seller is designated as being the package recipient who orders from the tier one customer big box store. That tier two customer can sign then up with a last mile shipping company and request that the big box store shipper utilize the services of the last mile shipping company. Otherwise, the last mile contractor franchisees could offer tier two customers the following services including utilizing last mile or existing doorbell security cameras, using a combination door handle or garage door entrance, and providing a secure porch box (SPB), such as an anchored weather-proof combination box in various sizes for rent or purchase.

Since the outbreak of COVID 19, nearly 1 in 5 Americans were victims of porch piracy. 18% had a package stolen. 43% had reported a package theft in the past. 54% of respondents had multiple deliveries stolen in the prior 12 months.

The advantages of the Last Mile Corporation's proprietary porch box will reduce package porch pirating as well as theft and weather damage.

Examples of preferred Secure porch box package and weight information are as follows: Some of the most common package sizes for a proprietary SPB may include a shipping box measuring 12″×12″×6″, 12″×12″×10″, 14″×14″×12″, 16″×14″×14″ or 20″×18″×12″.

The average size of an Amazon® or Walmart® package is a 1.5-cubic foot box, also known as a book box. It is considered the standard size for shipping boxes. Preferred dimensions are 16″×12″×12″. It also finds utility to pack small, heavy items such as CDs, records, canned products, books, power tools, etc. Current drone deliveries do not exceed 5 pounds or offer protected delivery.

In this proprietary concept for marketing franchises for the Last Mile Corporation's delivery service also included may be franchise expansion by acquisition.

Franchise Marketing Example: The central Last Mile Corporation will purchase freight companies or a delivery company with a gross freight revenue of $1,000,000 and install five (5) franchisees in the designated area. Each franchisee would pay an average of $118,000 for the Last Mile franchise rights, equipment and supplies. The franchisee would also pay $230,000 for their share of the local freight company acquisition purchase price. The total cost for Last Mile Corporation would be $1,000,000 business purchase price, with 30% down and a note for $700,000. Last Mile would take ownership of the freight company's equipment with a warranty from the seller. Any equipment adjustments or repairs would be subtracted from the back end of the $700,000 note.

The franchisee would start their business with $100,000 in revenue from the acquisition. The franchisee would also receive the revenue from the last mile tier one customers sellers.

The franchisees would pay the Central Last Mile corporation $1, 740,000 and last mile corporation will pay $300,000 down payment for the purchase of the local freight company. Thus, last mile corporation with have a net cash flow of $1,440,000.

It is also possible that the local trucking companies, managers and owners could be candidates for a Last Mile Franchise.

In one aspect of the present invention, a last mile master driver contractor could function as middle management when the system expands. The territories can be organized by zip code. In the case of heavily populated zip codes, there may be one or more territories in each zip code. The optional master franchisee's primary job is to become a facilitator of the economic activity and marketing for both the last mile territory driver contractor and the last mile delivery system. Thereafter, the last mile delivery contractor may be supported by a last mile master contractor. Both the last mile delivery contractor and the last mile master contractor will have to purchase delivery equipment and own or rent a designated drop off location. Master contract franchisees would receive a percentage based on how the gross earnings of the territories in their area perform. Duties of the master contract franchisees would require filling in for any subcontractors who fail and to assist in both the selection and training of replacements. Such a training program will be set up by the Central Last Mile Corporation.

Preferably, the master franchisee will have a back-up delivery equipment requirement and will be required to contact a percentage of the tier two customers monthly for each territory that they oversee. The last mile master contractor will also be required to submit a written territorial evaluation report to the Last Mile Corporation.

The last mile delivery contractor will be assigned a territory number and all interaction with both tier one and tier two customer sellers will refer to that territory number. The number of the contractor's territory may conform to the zip code in which the franchisee operates. The zip code could be the franchise number designation. For example, 48317 could be one last mile delivery concept. A second contractor could have 48317-A1 and the zip code 48317-A2 could be yet another contractor in the same zip code.

A successful last mile driver contractor could be promoted to a master contractor. This would require an additional franchise payment to the last mile delivery shipper, and the last mile contractor could sell their existing franchise to raise capital. Both the last mile delivery contractor and the last mile master contractor can own as many territories as they can afford and successfully manage.

Most likely the last mile delivery concept franchisee will sell his business to a family member. This will further increase the quality of the delivery service and may make it easier for a tier one customer seller to get away from their free freight dilemma. Tier two customers may accept freight price increases if they know a neighbor is receiving some of the benefits.

The tier two customer package delivery may be multiple times per day and the schedule should be published on the internet and on a mailbox or other suitable posting site in the territory. In the event that local ordinances are set up against the last mile delivery concept having a business in their home, several last mile delivery contractors and the master contractor can get together and share a rental in a local strip mall or other suitable site. This site with multiple last mile delivery concepts could also be convenient for tier two customers who are returning packages.

Additional certain benefits may include environmental social governance, ESG, standing and the environment. Because the last mile concept system lowers the number of vehicles required to deliver the packages, it dramatically helps the environment. Social benefits are also realized because the environmental social governance standing of the last mile contracting system will improve relations for most all of the companies who use delivery service personnel. This could either expand or reverse the desire to unionize. The last mile franchise concept could in some areas or states expand unionization if the union would accept the Last Mile Corporation contract. There is one main reason delivery service personnel workers are injured at such high rates, i.e. at the grueling speed that they are expected to work. The report cites complaints from delivery service personnel drivers and lawsuits from the delivery service personnel companies themselves that say Amazon® expects them to deliver a package every one to two minutes for 10 hours during the busiest times of the year. Workers also are afraid of being fired if they miss their unrealistic quotas. Amazon® also reportedly does not make accommodations for local conditions, such as heavy traffic, road construction, narrow streets that are difficult to navigate through or difficult terrain. Hostilities arise as a sign that Amazon® is exercising too much control over its subcontractors, and this may end up being adjudicated as its employees increasingly provide negative input. Good relationships will reduce the need for government involvement and may drastically reduce the injuries.

Reasons for penalizing or termination of a last mile concept may be covered in the initial executed franchise agreement. The last mile franchisee could be terminated or penalized for damaged packages, stealing, being late with deliveries, or a high number of undelivered packages. Furthermore, inadequate insurance coverage means that a last mile contractor's monthly franchise fee can include a charge for an auto insurance policy which would include auto liability coverage of $1,000,000, uninsured motorist/under-insured motorist coverage, and contingent comprehensive and collision coverage. Passengers will not be covered unless they are employees of the franchisee. In addition, failing a mandatory alcohol and/or urine drug testing requirement can also cause many problems.

In looking for the best choice for franchise candidate delivery contractors, it must be known that last mile franchisees can be homeowners or local businesses with an office in their territory. The last mile contractor can combine the last mile delivery system with any other independent home-based business. Examples would be snow plowing, firewood sales, lawn cutting service etc. One real advantage for the last mile delivery service is relatively low number of employees required to maintain a high degree of activity with an excellent return.

In yet another aspect, last mile contractors may avail themselves of additional services opportunities, such as they may offer delivery services to the general public for Amazon, Walmart®, Macy's®, Chipotle®, McDonald's®, Target®, Home Depot®, Sam's Club®, Costco® etc. Last mile contractors can also offer services by holding packages and picking up mail for their customers when they are traveling, arranging Uber® rides for customers who need them, and offering referral services for home repair and lawn service either from their personal experience or from local experts on call or retainer.

In order to expand their sales possibilities, last mile franchisees can easily offer additional services by distributing a list of the services that franchisees have available by direct advertisements to the franchisee's customers. The information could also be delivered to the franchisee's customers through a web site, e-mail, or hand out circular delivered by the franchisee.

It must be noted that the managerial people at the supplier stores 11, especially big box stores, have their hands full with delivery problems. The last mile franchise system will lower delivery driver problems, lower costs, and increase the overall package delivery volume. The average daily deliveries by an Amazon® delivery driver is between 150 and 385 depending on the size of the territory. The majority of the last mile franchisees will deliver packages within four miles of their home or office. Since the last mile franchisee will live in their territory, commuting time will be reduced and efficiency will be increased which will increase their profits. The fact that the last mile franchisees live in close proximity to their delivery territory will present a more relaxed work environment which may greatly reduce accidents, stress, and on the job injuries that exist today.

A particular benefit of the present invention is that the last mile structure will from time to time reduce current hostilities and increase overall delivery efficiencies by recruiting people who will realize the personal profit opportunities of owning and operating a last mile franchise. Part of the franchise simply will be the availability of various websites from the last mile company, including, but not limited to LastMileFranchise.com, LastMileLift.com, LastMileDealer.com, LastMileControl.com, LastMileFranchisor.com, LastMileLicensee.com, LastMileDistributor.com and LastMileCorporation.com.

Furthermore, in order to comply with environmental social governance standards, sustainability of the last mile delivery concept, keeping the data required for complying with environmental social governance standards, websites can be utilized for certification. Sustainability count assesses a company's environmental and social performance, measuring the gap between the values they state and their true objectives. Sustainability Ranking is a measure of how well a company is performing in terms of environmental and social responsibility. Sustainability Score is utilized for the assessment of a company's performance of social, environment, and economic principles.

| Age of family head | Median net | Average net |
|---|---|---|
| (or reference person) | worth | worth |
| Less than 35 | $39,000 | $183,500 |
| 35-44 | $135,600 | $549,600 |
| 45-54 | $247,200 | $975,800 |
| 55-64 | $364,500 | $1,566,900 |
| 65-74 | $409,000 | $1,794,600 |
| 75+ | $335,600 | $1,624,100 |

Source: The Federal Reserve's 2023 Survey of Consumer Finances

As with normal franchises, a territory fee will be assessed and purchased by the franchisee. Franchisee or contractor shall pay a fee for the territory and will acknowledge that he has read the last mile uniform franchise offering circular or licensee documents and agrees to the terms as written. The present inventor finds motivation for the last mile distributorship or franchise to purchase the territory, including demand for the service, net worth of the potential applicants, affordable entry price, economic work environment, quality customer-enhanced family life and spot-on economic and social timing. Actually, it is anticipated that the primary motivations for a purchase of a franchise from the last mile company will include the ever growing and increasing popularity and unparalleled demand for last mile delivery services.

Preferable Last mile franchisee profile will likely own a home, have a 401K, and would be tired of working for someone else, enjoy their family life and realizes that technologies in the form of AI and robotics are changing life as we know it.

Secondary motivations will likely include the quality of the multiple tier one customer sellers and the marketplace dominance that those tier one customer sellers enjoy, higher profits earned by the last mile franchisee due to the close proximity of their final destination tier two customers. A last mile franchisee can control their working hours and the time of packages in and time of packages out and relatively low overhead work from home or share an office close by with other last mile distributors or franchisees.

Furthermore, potential franchise purchasers will like the low equipment investment and relative ease to finance., including certain tax advantages when working with an office at home. Motivated workers may use family members which will make all parties less susceptible to current labor problems, and this business is unlikely to be replaced by artificial intelligence, drones, or robotics. Moreover, such a business will have an excellent resale value. The business can be passed on to the next generation.

In addition, promotion to a master franchisee position would allow multiple revenue sources as well as income from the sale of the original franchise. It is also possible to garner additional revenues from the tier two customer in their territory by simply offering service referrals i.e. landscaping, house cleaning, and home maintenance service referrals. Referral service would not involve additional overhead. Additional revenues could also be garnered from tier one customers' more efficient ways to handle returns and introducing product marketing incentives from tier one customers to tier two customers. Efficient handling of returns and product incentives would not involve additional revenue.

Looking now to tier one customer motivations, others would include independent contractor status, and could be a solution for today's volatile labor market with a motivated work force while tier two customer seller's motivations include having a familiar delivery personnel and improved residential package control and security, and improved safety with the secure porch box (SPB).

Therefore, the present invention discloses a franchise business model for last mile package delivery systems Including the steps of first establishing a franchise Corporation with a centralized computer system and selling franchises to a purchaser franchisee that is either a driver himself or he employs driver contractors within his designated territories and locations purchased by the franchisee.

When purchasing a franchise, the franchisee becomes interconnected within at least one logistic server computer within the centralized computer system for receiving information about package orders from the tier 1 seller that has entered into a business relationship with the franchisee by establishing a business relationship with a number of tier 1 sellers that will transmit order information from their buyers acting as tier two customers to the centralized computer system of the franchise corporation for coordination. The centralized computing system is connected with franchisee driver contractors to transmit information about the order and the address of the ultimate destination of the tier two customer.

In response to receiving an order, the centralized logistics systems computer relays information to the seller and the last mile driver contractor franchisee, and packages those orders to be delivered by a last mile franchisee driver contractor within his designated territory owned by the franchisee. Having a designated delivery from the number of tier one sellers will drop off those packages at a central location for the last mile driver to be picked up by the last mile driver contractor. The last mile driver contractor than retrieves those packages from his designated location and then delivers them to the ultimate destination of the tier two buyer customers.

By employing this new business model, the initial driver contractor of the tier one seller only has to deliver a multitude of packages to a centralized location within a last mile driver territory, such that the seller's driver contractor does not make deliveries individually outside the designated territory as that responsibility has been transferred to the franchisee driver contractor.

In summary, numerous benefits have been described which result from employing any or all of the concepts and the features of the various specific aspects of the present invention, or those that are within the scope of the invention. The franchise business model acts perfectly to eliminate redundancy with the original supplier delivery vehicle.

The foregoing description of a preferred aspect of the invention has been presented for purposes of illustration and description. It is not intended to be to be exhaustive or to limit the invention to the precise form disclosed. Obvious modifications or variations are possible in light of the above teachings with regards to the specific aspects. The aspect was chosen and described in order to best illustrate the principles of the invention and its practical applications to thereby enable one of ordinary skill in the art to best utilize the invention in various aspects and with various modifications as are suited to the particular use contemplated. It is intended that the scope of the invention be defined by the claims which are appended hereto.

1. A franchise business model for last mile package delivery systems;
establishing a franchise corporation with a centralized computer system;
selling franchises to a purchaser franchisee employing driver contractors within designated territories and locations purchased by the franchisee;
interconnecting at least one logistic server computer within the centralized computer system for receiving information about package orders from the tier 1 seller;
establishing a business relationship with a number of tier 1 sellers that transmit order information from their buyers acting as tier two customers to the centralized computer system of the franchise corporation for coordination with franchisee driver contractors to transmit information about the order and the address of the ultimate destination of the tier two customer;
in response to receiving an order, the logistics systems computer relays information to the seller and packages those orders to be delivered by a last mile franchisee driver contractor within his designated territory owned by the franchisee and having a designated delivery from the number of tier one sellers to drop off those packages at a central location for the last mile driver to be picked up by the last mile driver contractor; and
retrieving those packages by the last mile driver contractor from his designated location and then delivering them to the ultimate destination of the tier two buyer customers,
whereby the initial driver contractor of the tier one seller only has to deliver a multitude of packages to a centralized location within a last mile driver territory, such that the sellers driver contractor does not make deliveries individually outside the designated territory as that responsibility has been transferred to the franchisee driver contractor.
